(19) United States
(12) Patent Application Publication
(10) Pub. No.: US 2023/0418907 A1
(43) Pub. Date: Dec. 28, 2023

(54) NETWORK STATE MODELLING

(71) Applicants: Nokia Solutions and Networks Oy, Espoo (FI); TECHNISCHE UNIVERSITÄT MÜNCHEN, Munich (DE)

(72) Inventors: Márton KAJÓ, Munich (DE); Benedek SCHULTZ, Budapest (HU); Stephen MWANJE, Munich (DE)

(21) Appl. No.: 18/252,861

(22) PCT Filed: Nov. 2, 2021
(86) PCT No.: PCT/IB2021/060108

§ 371 Date: May 12, 2023

(30) Foreign Application Priority Data
Nov. 17, 2020 (FI) 20206162

(51) Int. Cl. G06F 18/23; G06F 18/15; G06F 18/2134

(52) U.S. Cl. CPC G06F 18/23; G06F 18/15; G06F 18/21345

(57) ABSTRACT

Apparatuses and methods in a communication system are disclosed. In a network element, an encoder module obtains as an input network data that is representative of the current condition of the communications network, the network data comprising a plurality of values indicative of the performance of network elements and performs (800) feature reduction providing at its output a set of activations. A clustering module performs (802) batch normalisation and an amplitude limitation to the output of the encoder module to obtain normalised activations. A clustering control module calculates a projection of the normalised activations and determines (804) a clustering loss. A decoder module calculates (806) a reconstruction loss. The network element backpropagates the reconstruction loss and the clustering loss through the modules.

### FIELD

The exemplary and non-limiting embodiments of the invention relate generally to wireless communication systems. Embodiments of the invention relate especially to apparatuses and methods in wireless communication networks.

### BACKGROUND

The use of wireless communication systems is constantly increasing in many application areas. Communication that was previously realised with wired connections is replaced by wireless connections as the wireless communication systems offer many advantages over wired systems.

The modern communication systems are huge complex systems. Management of such systems is a difficult task because of the sheer amount of data which is involved in the management process. Therefore, new solutions are required so that the important management operations can be performed reliably.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to a more detailed description that is presented later.

According to an aspect of the present invention, there is provided an apparatus of claim 1.

According to an aspect of the present invention, there is provided a method of claim 8.

According to an aspect of the present invention, there is provided a computer program of claim 14.

One or more examples of implementations are set forth in more detail in the accompanying drawings and the description below. Other features will be apparent from the description and drawings, and from the claims. The embodiments and/or examples and features, if any, described in this specification that do not fall under the scope of the independent claims are to be interpreted as examples useful for understanding various embodiments of the invention.

### LIST OF DRAWINGS

Embodiments of the present invention are described below, by way of example only, with reference to the accompanying drawings, in which

FIGS. 1 and 2 illustrate examples of simplified system architecture of a communication system;

FIG. 3 illustrates a simple example of a state model and transitions;

FIG. 4 illustrates a schematic example of a conventional autoencoder;

FIG. 5 illustrates a schematic example of an autoencoder of an embodiment:

FIGS. 6A and 6B illustrate examples of training;

FIG. 7 illustrates a state transition graph output of a deep clustering autoencoder;

FIG. 8A is a flowchart illustrating an embodiment;

FIGS. 8B, 8C, 8D and 8E illustrate an example of gradual limitation of the freedom of representation;

FIGS. 9 and 10 are flowcharts illustrating embodiments;

FIG. 11 illustrates an example of a clustering module;

FIG. 12 illustrates an example of a training procedure of the autoencoder;

FIGS. 13A, 13B, 13C, 13D, 13E and 13F illustrate an example of how activations are moved to more and more constrained spaces during training;

FIG. 14 illustrates the use of the autoencoder during inference; and

FIG. 15 illustrate a simplified example of an apparatus applying some embodiments of the invention.

### DESCRIPTION OF SOME EMBODIMENTS

The following embodiments are only examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may also contain features, structures, units, modules etc. that have not been specifically mentioned.

Some embodiments of the present invention are applicable to a user terminal, a communication device, a base station, eNodeB, gNodeB, a distributed realisation of a base station, a network element of a communication system, a corresponding component, and/or to any communication system or any combination of different communication systems that support required functionality.

The protocols used, the specifications of communication systems, servers and user equipment, especially in wireless communication, develop rapidly. Such development may require extra changes to an embodiment. Therefore, all words and expressions should be interpreted broadly and they are intended to illustrate, not to restrict, embodiments.

In the following, different exemplifying embodiments will be described using, as an example of an access architecture to which the embodiments may be applied, a radio access architecture based on long term evolution advanced (LTE Advanced, LTE-A) or new radio (NR, 5G), without restricting the embodiments to such an architecture, however. The embodiments may also be applied to other kinds of communications networks having suitable means by adjusting parameters and procedures appropriately. Some examples of other options for suitable systems are the universal mobile telecommunications system (UMTS) radio access network (UTRAN), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

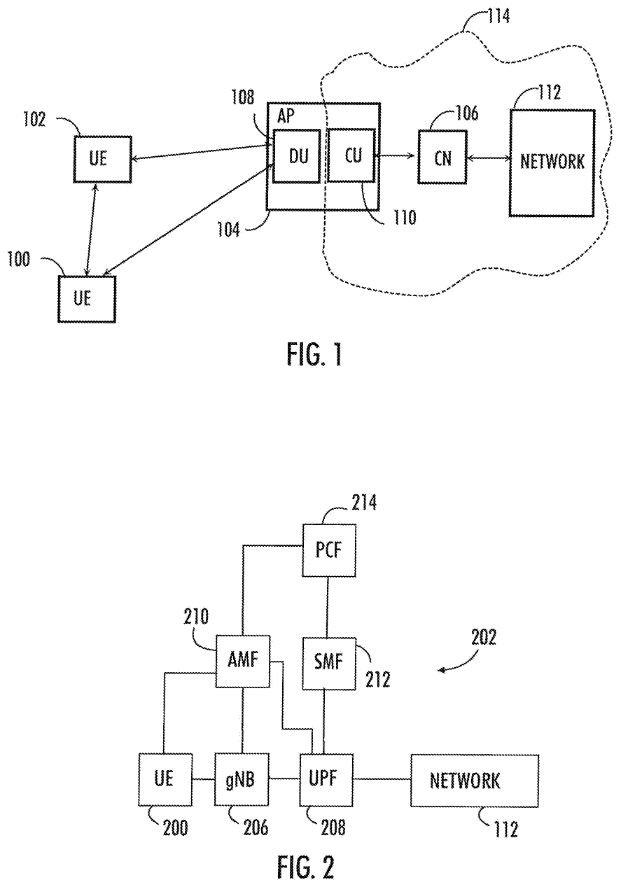

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

The example of FIG. 1 shows a part of an exemplifying radio access network.

FIG. 1 shows devices 100 and 102. The devices 100 and 102 are configured to be in a wireless connection on one or more communication channels with a node 104. The node 104 is further connected to a core network 106. In one example, the node 104 may be an access node such as (e/g)NodeB serving devices in a cell. In one example, the node 104 may be a non-3GPP access node. The physical link from a device to a (e/g)NodeB is called uplink or reverse link and the physical link from the (e/g)NodeB to the device is called downlink or forward link. It should be appreciated that (e/g)NodeBs or their functionalities may be implemented by using any node, host, server or access point etc. entity suitable for such a usage.

A communications system typically comprises more than one (e/g)NodeB in which case the (e/g)NodeBs may also be configured to communicate with one another over links, wired or wireless, designed for the purpose. These links may be used for signalling purposes. The (e/g)NodeB is a computing device configured to control the radio resources of communication system it is coupled to. The NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to devices. The antenna unit may comprise a plurality of antennas or antenna elements. The (e/g)NodeB is further connected to the core network 106 (CN or next generation core NGC). Depending on the deployed technology, the (e/g)NodeB is connected to a serving and packet data network gateway (S-GW+P-GW) or user plane function (UPF), for routing and forwarding user data packets and for providing connectivity of devices to one ore more external packet data networks, and to a mobile management entity (MME) or access mobility management function (AMF), for controlling access and mobility of the devices.

Exemplary embodiments of a device are a subscriber unit, a user device, a user equipment (UE), a user terminal, a terminal device, a mobile station, a mobile device, etc

The device typically refers to a mobile or static device (e.g. a portable or non-portable computing device) that includes wireless mobile communication devices operating with or without an universal subscriber identification module (USIM), including, but not limited to, the following types of devices: mobile phone, smartphone, personal digital assistant (PDA), handset, device using a wireless modem (alarm or measurement device, etc.), laptop and/or touch screen computer, tablet, game console, notebook, and multimedia device. It should be appreciated that a device may also be a nearly exclusive uplink only device, of which an example is a camera or video camera loading images or video clips to a network. A device may also be a device having capability to operate in Internet of Things (IoT) network which is a scenario in which objects are provided with the ability to transfer data over a network without requiring human-to-human or human-to-computer interaction, e.g. to be used in smart power grids and connected vehicles. The device may also utilise cloud. In some applications, a device may comprise a user portable device with radio parts (such as a watch, earphones or eyeglasses) and the computation is carried out in the cloud.

The device illustrates one type of an apparatus to which resources on the air interface are allocated and assigned, and thus any feature described herein with a device may be implemented with a corresponding apparatus, such as a relay node. An example of such a relay node is a layer 3 relay (self-backhauling relay) towards the base station. The device (or in some embodiments a layer 3 relay node) is configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected information and communications technology, ICT, devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, e.g. below 6 GHz or above 24 GHz, cmWave and mmWave, and also being integrable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, 6 or above 24 GHz-cmWave and mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks 112, such as a public switched telephone network, or a VoIP network, or the Internet, or a private network, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

The technology of Edge cloud may be brought into a radio access network (RAN) by utilizing network function virtualization (NFV) and software defined networking (SDN). Using the technology of edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at or close to a remote antenna site (in a distributed unit, DU 108) and non-real time functions being carried out in a centralized manner (in a centralized unit, CU 110).

It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano)satellites are deployed). Each satellite in the mega-constellation may cover several satellite-enabled network entities that create on-ground cells. The on-ground cells may be created through an on-ground relay node or by a gNB located on-ground or in a satellite.

It is obvious for a person skilled in the art that the depicted system is only an example of a part of a radio access system and in practice, the system may comprise a plurality of (e/g)NodeBs, the device may have an access to a plurality of radio cells and the system may comprise also other apparatuses, such as physical layer relay nodes or other network elements, etc. At least one of the (e/g)NodeBs or may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H(e/g)nodeBs), a home node B gateway, or HNB-GW (not shown in FIG. 1). A HNB Gateway (HNB-GW), which is typically installed within an operator's network may aggregate traffic from a large number of HNBs back to a core network.

FIG. 2 illustrates an example of a communication system based on 5G network components. A user terminal or user equipment 200 communicating via a 5G network 202 with a data network 112. The user terminal 200 is connected to a Radio Access Network RAN node, such as (e/g)NodeB 206 which provides the user terminal with a connection to the network 112 via one or more User Plane Functions, UPF 208. The user terminal 200 is further connected to Core Access and Mobility Management Function, AMF 210, which is a control plane core connector for (radio) access network and can be seen from this perspective as the 5G version of Mobility Management Entity, MME, in LTE. The 5G network further comprises Session Management Function, SMF 212, which is responsible for subscriber sessions, such as session establishment, modify and release, and a Policy Control Function, PCF 214 which is configured to govern network behavior by providing policy rules to control plane functions.

Management of modern communication systems such as LTE or NR based systems is a challenging task. The systems comprise hundreds of devices communicating with each other with numerous interfaces. The amount of network data related to management is large and constantly changing, due to the mobility of terminal devices, for example. Parameters used in the management comprise Key Performance Indicators (KPIs), among others. These parameters may comprise multi-dimensional streams of data obtained from various network elements, such as Radio Access Network (RAN) nodes, terminal device, Core Network elements and various network servers, for example.

The management of 5G based networks present even a greater challenge because of the complex structure and properties of the networks. The operations of the fixed network are realised in many cases at least partly as a cloud service with a plurality of interconnected servers in many layers. Network function virtualization (NVF) and software defined networking (SDN) increase the complexity of the network. The number of terminal devices is expected to increase dramatically due to Internet-Of-Things.

Cognitive Network Management (CNM) has been proposed as a tool for performing network management tasks that require higher cognitive capabilities than what hard-coded management functions can implement. To realize these reasoning capabilities, Cognitive (management) Functions (CFs) need to gather information from different domains, layers and aspects of the network. This varied information is contained in data streams or files, which are made up of hundreds, if not thousands of features.

Network State Modelling has been developed to overcome the inherent complexity of working with these many features. By assigning all possible combination of measurements to a finite amount of Network States, it is possible to use algorithms on the dataset which would otherwise be overwhelmed by either the sheer volume of, or the variance contained within the datasets. Additionally, Network States are also more comprehensible to humans than raw values, making understanding the models formed by learning algorithms easier. This understanding helps in establishing trust between the human operator and the machine, which is critical for the wide-scale adoption of automation of high-cognitive tasks, such as Cognitive Network Management.

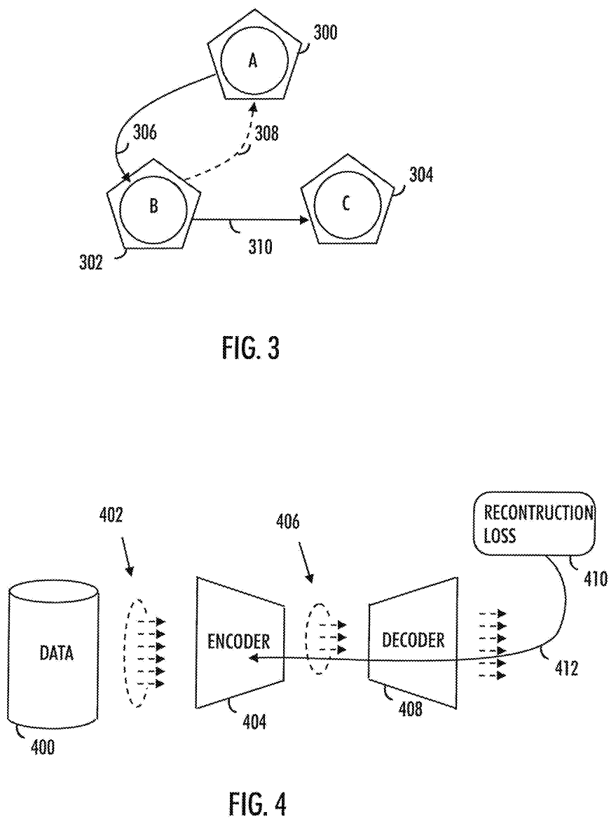

FIG. 3 illustrates a simple example of a state model and state transition map for a cell of a communication system. The model has three states, A: Normal operation 300, B: A spike in downlink load 302 and C: Congestion 304. Three possible transitions are shown: a transition 406 from A to B, a transition 408 from B to A and transition 310 from B to C.

At present, Deep Neural Networks are the strongest machine learning algorithms in terms of modelling capacity. They have a resiliency against noise and irrelevant features, as well as just generally being able to process high amounts of relevant features. Therefore, Deep Neural Networks are able to work with very high-dimensional input data. A special type of Deep Neural Networks called Deep Autoencoders can transform input data into a low-dimensional space, learning and modelling the behaviour of the system that generated the data in the process. In general, Autoencoders comprise two parts: an encoder and a decoder network. The simplified, lower-dimensional representation (the encoding) can be found between these parts, in the middle of the autoencoder Because of the lower dimensional representation they produce, (deep) autoencoders are often used for feature reduction.

FIG. 4 illustrates a schematic example of a conventional autoencoder. The autoencoder receives input data 400, which has a high number 402 of features that are the input to the encoder 404. The encoder 404 performs the encoding and at its output are a reduced number 406 of features. These may be applied as input to the decoder 408. The difference between the decoder output and the input data may be denoted as reconstruction loss 410, which can be fed back to the autoencoder as backpropagation 412 and used to train the system.

When Network State Modeling is used, the quality of the defined network states is important regarding the possible performance of later Cognitive Functions, which use the formed states as input. Each Cognitive Function has its own requirements for the quality of each state. Thus, while a State Model could be performing well with one Cognitive Function, the same State Model might be underperforming with another Cognitive Function. Although it would be possible to alleviate this problem by creating a state model for each Cognitive Function separately, this would increase the computational overhead considerable and lead to non-uniform description of the network which are undesirable features and reduce the overall efficiency the model.

Instead of creating multiple subjective state models per Cognitive Function, the inventors have realised that it is necessary to form an all-encompassing objective state model, one that incorporates all important logical connections in how the network behaves. Since this objective model is not specific to any Cognitive Function, it would need to be trained on unsupervised (non-labelled) training data from the network, data which contains many aspects (features) of the network behaviour.

Usually, Network State Modelling is solved by common clustering or vector quantization techniques. However, regular clustering methods do not work well datasets with a large number of features, in other words in high-dimensional spaces. This is due to the fact that they rely on distance as a quality indicator for the quantization fit, measured directly on the input data. However, distances, especially Euclidean distance, are susceptible of becoming irrelevant in high-dimensional spaces, depending on the distribution of the observations. To counteract this, environmental modelling systems often use a feature reducer pre-processor to reduce the number of input features going into the clustering.

In prior art, both the feature reduction and the clustering are optimized for their own error measures, thus is no connection between the two models and their optimisation. The output of the feature reducer can be detrimental to the overall state modelling task, while both the feature reduction and the quantization producing numerically low error values individually. Thus, combining the feature reduction and the clustering as such leads again to undesirable features and reduced overall operation.

As a solution to above problems, the inventors are proposing an autoencoder deep neural network, which is configured to comprise integrate a clustering functionality, denoted as a deep clustering autoencoder (DCA). The DCA is capable to merging the features reduction and clustering aspects of the Network State Modeling systems into one single trained model, improving on the performance of both tasks simultaneously.

FIG. 5 illustrates a schematic example of an autoencoder of an embodiment. The autoencoder receives input data 400, which acts as the input to the encoder 404. The encoder 404 as such can be realised as in prior art. In an embodiment, the proposed autoencoder further comprises a decoder 408 which likewise can be realised as in prior art. Between the encoder 404 and decoder 408, which provide the feature reduction power of the system, are located a clustering module 500 and a clustering control module 502. The clustering module 500 takes as input the encoded output from the encoder 404, while the control module 502 takes as input the output of the clustering module.

The clustering module 500 formation of the states (clusters) within the encoded representation, and the linear transitions between the states or clusters. The clustering control module is configured to determine a clustering loss, which is used as a control input in the clustering module 500 when performing the clustering of data.

In an embodiment, a sparsity constraint 504 is utilised as an input for the clustering control module 502 which control the formation of clusters. The value of the sparsity constraint can be selected by during training of the autoencoder by the user.

The proposed autoencoder is configured to automatically learns or models a state-transition graph. This graph is useful for further processing steps, such as anomaly detection, network state prediction, predictive slice control, and visualization, for example. The output of the system is a linear combination of candidate states (clusters).

In an embodiment, when propagated through the decoder, the linear transitions in the encoding are mapped to non-linear but logical combinations of the cluster centroids in the original space of the data.

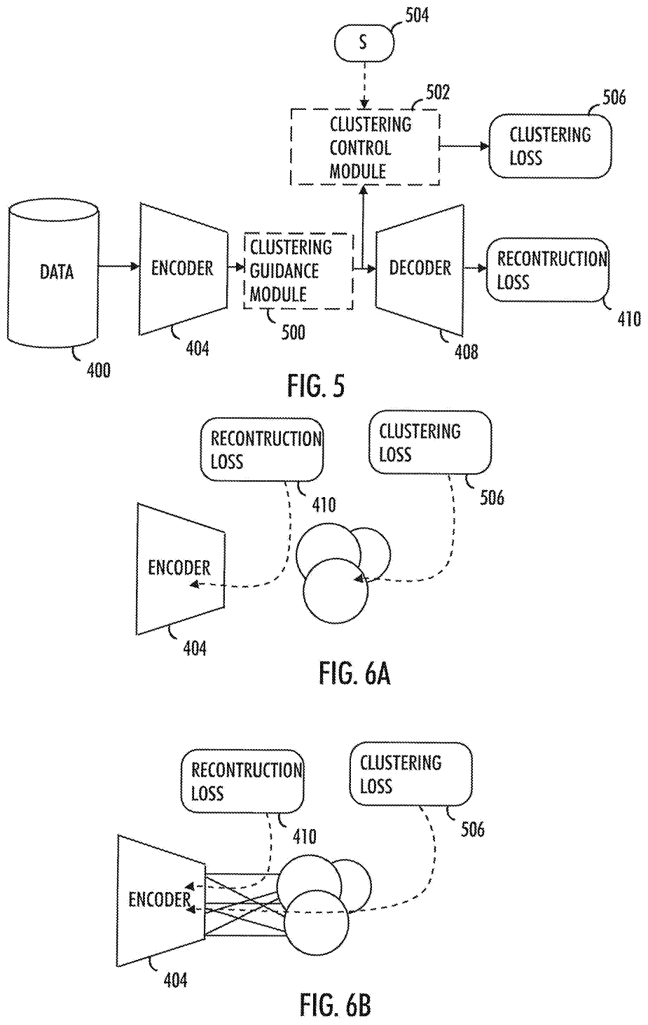

In prior art in environmental modelling systems, the feature extractor and the clustering algorithm is trained in separate stages. This is illustrated in FIG. 6A. The reconstruction loss 410 is applied to the feature reduction and the clustering loss 506 to clustering. This may be denoted as decoupled training. In contrast, the proposed solution applies a so-called coupled training, illustrated in FIG. 6B, where the autoencoder is trained with both the clustering loss 506 and the reconstruction loss 410 in place at the same time. This removes the possibility of a subjectively good but objectively bad feature reduction or clustering (as explained above). In an embodiment, by training the neural network on data extracted from a mobile network, the formed clusters become Network States, and the DCA realizes network state modelling.

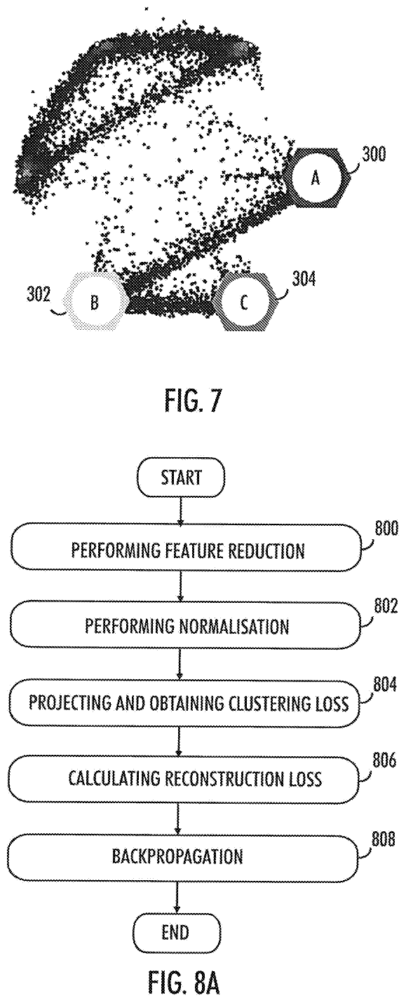

In the proposed solution, the learned encoding in the autoencoder is representative of a state transition graph of the communication system which data was used in the learning process. FIG. 7 illustrates a state transition graph output of a deep clustering autoencoder where learning was based on the state model and state transition map for a cell of a communication system as illustrated in FIG. 3. The state transition graph illustrates the three states, A: Normal operation 300, B: A spike in downlink load 302 and C: Congestion 304 and transitions between the states. This makes the learned model easily interpretable by humans, as well as simplifying the decision-making process in subsequent Cognitive Functions, CFs, that use this information as input.

As mentioned, prior clustering methods for mobile network state modelling either operate on the raw high-dimensional data or use a decoupled feature extractor and quantizer. However, as traditional clustering methods do not work well on high-dimensional data, the former case is unadvisable. On the other hand, the feature extractor based solutions often obfuscate part of the data, making the job of the clustering method harder and consequently the results worse. The proposed solution uses a coupled feature extractor and clustering, which allows them to influence each other during training. This produces better clusters and better defined cluster prototypes.

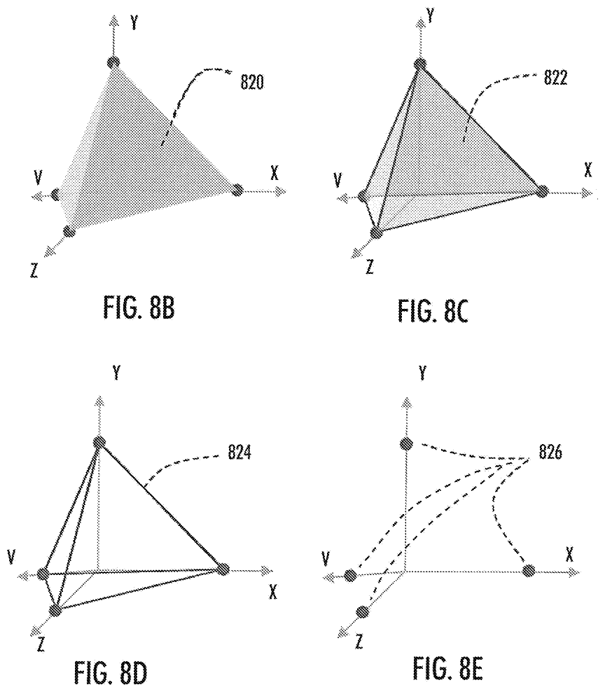

The flowchart of FIG. 8A illustrates an embodiment of the proposed solution. The flowchart illustrates an example of the operation of a network element or a part of a network element for network state modelling of a communication network n apparatus. In an embodiment, the steps may be divided to be performed by multiple network elements.

In step 800, an encoder module of the network element is configured to obtain, as an input, network data that is representative of the current condition of the communications network, the network data comprising a plurality of values indicative of the performance of network elements and perform feature reduction providing at its output a set of activations.

In step 802, a clustering module of the network element is configured to perform batch normalisation and an amplitude limitation to the output of the encoder module to obtain normalised activations.

In step 804, a clustering control module of the network element is configured to obtain, as an input, a sparsity constraint, and to calculate a projection of the normalised activations by utilising a mask controlled by the sparsity constraint and determining a clustering loss which controls the clustering module by calculating distance between the normalised activations and the projection.

In an embodiment, the mask removes the smallest activations based on the sparsity constraint.

In step 806, a decoder module of the network element is configured to form reconstructed network data from the normalised activations and determine a reconstruction loss.

In step 808, the network element is configured to backpropagate the reconstruction loss and the clustering loss through the modules of the network element to train the modules by gradually reducing the value of the sparsity constraint.

In an embodiment, the network element is configured to gradually reduce the value of the sparsity constraint below the range of [0,1].

Thus, in an embodiment, utilising a specific projection of the encoding and a new loss measured on the projection, clustering with a Deep Autoencoder may be achieved.

In an embodiment, the encoder-decoder pair is a symmetrical pair of multilayer sub-networks, encapsulating multiple fully-connected layers. The reconstruction loss may be defined as a mean-squared error function between the input of the encoder and the output of the decoder, used to train the encoder and the decoder.

The encoder module receives as an input network data and produces as an output activations Q. These activations Q are the observations encoded by the encoder module and subsequently modified by the clustering guidance module. The clustering guidance module performs batch normalisation followed by an amplitude limitation and because of this the activations in Q are limited to values between 0 and 1 (Q is limited to the unit hypercube), Q∈[0,1]^{D} where D denotes the dimensionality of the data.

In an embodiment, the network element realising the deep autoencoder as a neural network comprises a novel clustering control module. The clustering control module operates on the data encoded by the encoder module of the network element and influences the encoded a representation of the data to meet the following criteria:
1. Sparse representation, that represents the data using a linear (convex) combination in the encoding space.
2. Capable of a gradual decrease of modelling freedom during the training of the neural network.

In an embodiment, the clustering control module enforces a clustering that contains interpretable, probable prototypes as cluster centroids in the original input space of the data. This means that the inputs that maximally activate the representing nodes in the clustering layer are inputs that are naturally occurring, realistic (or even truly real) datapoints, instead of abstract, non-interpretable and unrealistic shapes which are common in sparse representations.

Let us study the calculation of clustering loss performed by the clustering control module. The clustering loss calculation mechanism is designed to be able to enforce convex combination of the representation of inputs in the encoding, with a sparsity constraint or a degree of freedom s∈[0, D−1], where the activation is denoted with Q∈[0,1]^{D}. This essentially corresponds to having in the embedding space of [0,1]^{D} a convex combination of s+1 points. To realize this, a projection of Q (called an anchor point, \tilde{Q}) is calculated. In layman's terms, for every encoded activation, an anchor point is calculated, the anchor point being the closest to the original activation but fulfilling the constraint on freedom (defined by to the sparsity constraint s). In an embodiment of the proposed solution, the value of s is gradually reduced somewhere between the range of [0,1], depending on the dataset.

FIGS. 8B, 8C, 8D and 8E illustrate an example of gradual limitation of the freedom of representation in 4 dimensions. By lowering the value of s, the freedom is gradually limited. In FIG. 8B, s equals to 3 and the freedom corresponds to the whole tetrahedron 820. In FIG. 8C, s equals to 2 and the freedom corresponds to the faces 822 of the tetrahedron 820. In FIG. 8D, s equals to 1 and the freedom corresponds to the edges 824 tetrahedron 820. In FIG. 8E, s equals to 0 and the freedom corresponds to the cluster prototypes or the corners of the tetrahedron 826.

The network element is configured calculate clustering loss as the (Euclidean) distance between the original activation and the anchor point. If the anchor point is the same as the original activation, the clustering loss is 0 for that specific observation, if the original activation is already situated within the confined space defined by the sparsity constraint s.

In the calculation of the anchor point, a base change is first calculated, the base change enabling projecting the original activation into the anchor point by a simple masking of values. In an embodiment, the base change matrix needs to be precomputed only once before training, so it enables an efficient projection for different values, without need of lengthy projection re-computations.

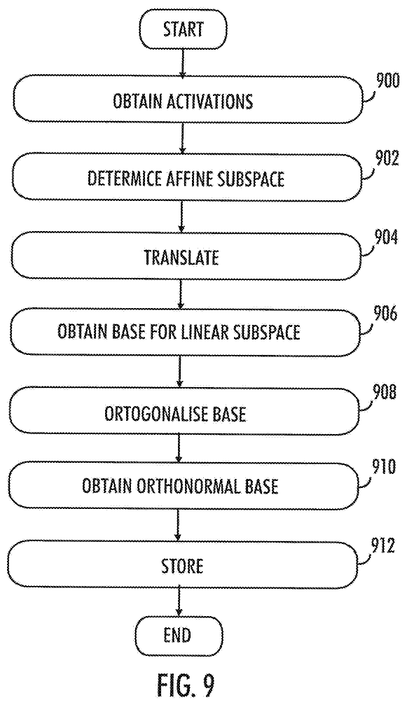

The flowchart of FIG. 9 illustrates an embodiment. The flowchart illustrates an example of the operation of a network element or a part of a network element for pre-processing computation for base change.

In step 900, the network element is configured to obtain as an input the output of the clustering module Q. In an embodiment, the points of the sum Qᵢ equal to 1.

In step 902, the network element is configured to calculate affine subspace B={b₁, b₂, . . . , b_{D}} based on Q.

In step 904, the network element is configured to translate B with t=−b₁, to obtain B̅={0, b₂−b₁, . . . , b_{D}−b₁}.

In step 906, the network element is configured to obtain base of the linear subspace B={b₂−b₁, . . . , b_{D}−b₁} which spanned by B;

In step 908, the network element is configured to orthogonalize the base using a Gram-Schmidt orthogonalization to obtain orthogonalized A;

In step 910, the network element is configured to add a unit length vector to A to obtain an orthonormal base as a matrix whose column are the elements of A.

In step 912, the network element is configured to form a matrix A whose column are the elements of A and store A and t.

The above defined values are utilised in the computation of the clustering loss in the clustering control module 502.

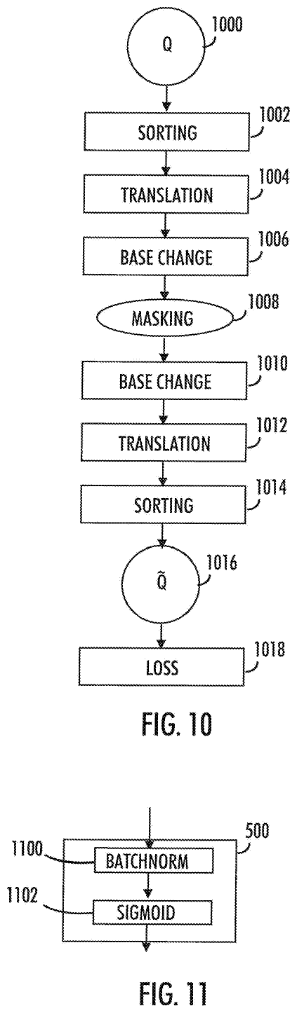

The flowchart of FIG. 10 illustrates an embodiment. The flowchart illustrates an example of the operation of a network element or a part of a network element the computation of the clustering loss during training of the neural network. In an embodiment, the steps are performed at least in part in the clustering control module 502.

In step 1000, the network element is configured to obtain as input the output activations of the clustering module Q;

In step 1002, the network element is configured to sort the input in a descending order a=sort_{desc}(Q);

In step 1004, the network element is configured to translate the sorted input by subtracting the value t: a=Q−t.

In step 1006, the network element is configured to change the base of the translated input to an orthonormal base utilising a transpose of the matrix A: a=a A^{T}

In step 1008, the network element is configured to calculate the projection of the input data by multiplying the projection with the mask controlled by the given sparsity constraint: s: a=aμ(s).

In an embodiment, the mask μ(s) removes the smallest activations based on the sparsity constraint. In an embodiment, the mask μ(s) is a vector comprising values between 0 and 1 based on the sparsity constraint s.

In step 1010, the network element is configured to change the base back to non-orthonormal utilising the matrix A: a=a A.

In step 1012, the network element is configured to perform detranslation by adding the value t: a=a+t.

In step 1014, the network element is configured to perform unsorting to obtain anchor points \tilde{Q}=unsort(a).

In step 1016, the network element is configured to calculate clustering loss by determining distance between the anchor points \tilde{Q} and the activations Q: loss clustering=dist (Q, \tilde{Q}).

Thus, in an embodiment, the μ(s) mask is a vector containing values between 0s and 1s. The mask multiplies the sorted activation, effectively “turning off” activations that are the smallest. The sparsity constraint s value describes what values the mask takes. As an example, μ(2.0)=[1.0, 1.0, 0.0], μ(1.8)=[1.0, 0.8, 0.0], μ(1.2)=[1.0, 0.2, 0.0], μ(0.6)=[0.6, 0.0, 0.0], . . . .

One input to the clustering control module 502 is the output of the clustering module 500.

As illustrated in FIG. 11, in an embodiment, the clustering module 500 comprises two modules: a weight-shared batch normalization module 1100, and a sigmoid nonlinearity module 1102. These modules take place in the main forward-propagation path, and directly modify the output of the encoder 404. The clustering is then enforced by the clustering control module 502.

If clustering loss were utilised without any additional mechanisms, there might be a problem of not properly exploring the encoding space at the beginning of the training. This may lead to a reduced performance due to the encoding not utilizing all the available cluster centers for representation.

In an embodiment, to remove the above problem, the clustering module 500 comprises a weight-shared batch-normalization module 1100 followed by a sigmoid nonlinearity module 1102. The weight-shared batch-normalization module does the following operation:

y_{batchnorm}=x−mean(x)std(x)*p_{scale}+p_{offset},

where x is the input, while p_{scale} and p_{offset} are the learnable parameters of the batchnorm neural network layer. In a traditional batchnorm layer these are learned per feature. However, as the purpose here is to keep the centering effect all through the training, the parameters are shared between the features. This is a novel technique.

As mentioned in connection with FIG. 6B, when both reconstruction and clustering losses are computed in learning process, they are back propagated to all the neural network parts and each unit of the neural network, and the extent to which that unit contributed to the loss is determined. Then the value of that unit is adjusted to try and minimize the loss. Thus, also p_{scale} and p_{offset} are also adjusted during the learning phase depending on the observed losses. In an embodiment, all activation of the data is passed through the batch normalization neural network portion and the above equation using the p_{scale} and p_{offset} values is applied to all the activations. Thus, the values are being shared among all the features/dimensions/activation of the data.

The batch-normalization module is followed by the sigmoid nonlinearity module. As such, the use of sigmoid nonlinearity is known in neural networks, but here it is specifically there to limit the amplitude of the activations, limiting every value to the range of [0,1]. This ensures the probability-like nature of the encoded vectors.

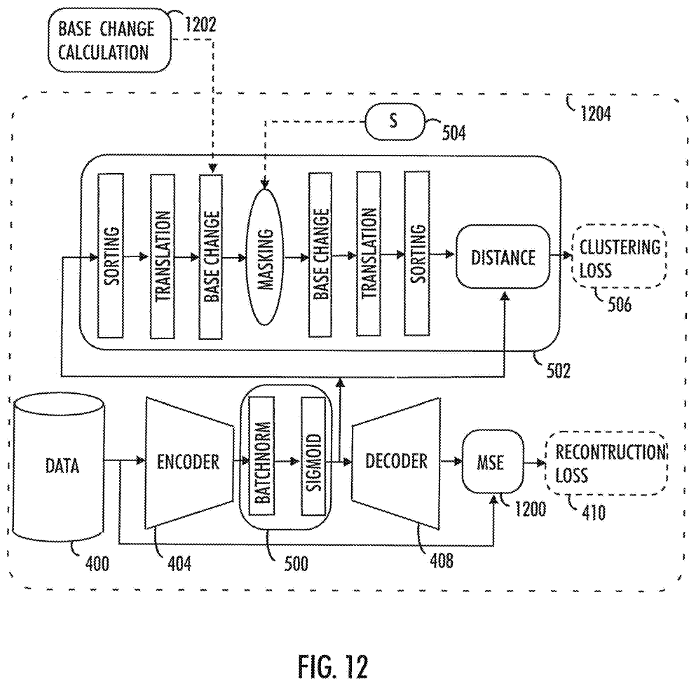

FIG. 12 illustrates an example of a training procedure of the autoencoder. As mentioned in connection with FIG. 5, the autoencoder receives input data 400, processes data with the encoder 404, the clustering module 500, and decoder encoder 404. The reconstruction loss 410 utilising mean-squared error 1200, for example. The clustering loss 506 is calculated in the clustering control module 502.

First the base change calculation 1202, illustrated in FIG. 9, is performed in the preparation phase of the use of the autoencoder.

In the training phase 1204, after the preparation phase, the autoencoder network is trained by backpropagating the clustering and reconstruction losses. The value of the sparsity constraint s 504 is gradually reduced to somewhere between the range of [0,1]. In an embodiment, this produces an encoded representation of linear combination of centroids with at most two active centroids.

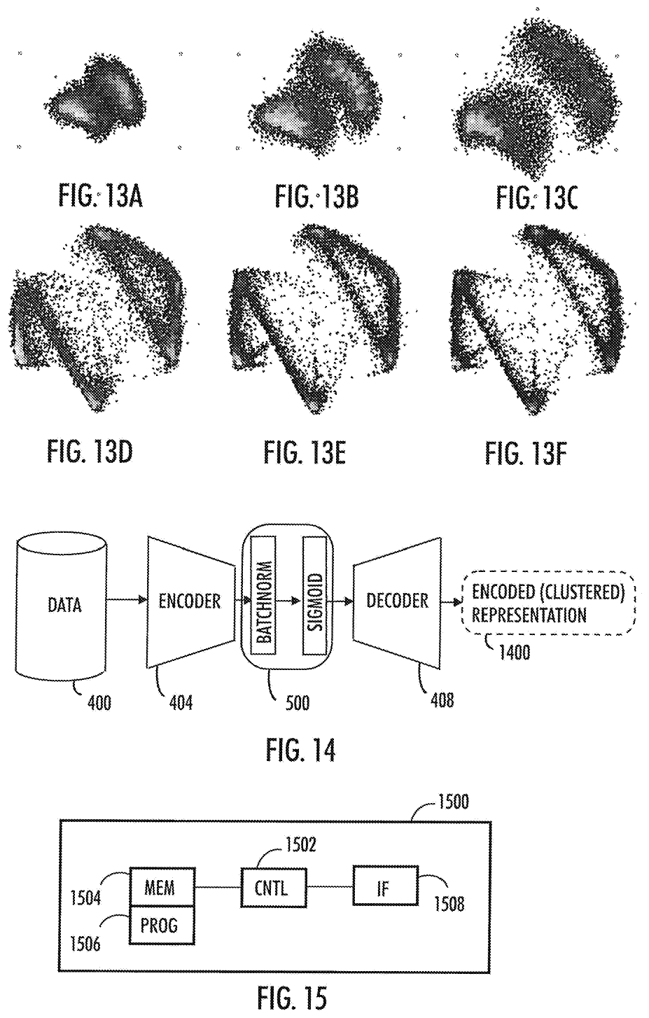

FIGS. 13A, 13B, 13C, 13D, 13E and 13F illustrate an example of how the activations are moved to more and more constrained spaces during training FIG. 13A illustrates the situation in the beginning of the training where s equals 5.0, in FIG. 13B s equals 3.680, in FIG. 13C s equals 2.347, in FIG. 13D s equals 1.013 and in FIG. 13E s equals 1.0 and at the end of the training in FIG. 13F s equals 1.0. In FIG. 13F clustering and linear transitions have been achieved.

FIG. 14 illustrates the use of the autoencoder during inference. After the training phase, during inference, the trained model can be used for clustering by propagating observations through the encoder 404, and the clustering module 500. The resulting output 1400 represents cluster affiliation probabilities for each observation. Because the clustering control module is only used to enforce the correct learning of the encoding in the training phase, it is not needed at inference.

Few systems produce the kind of multidimensional data that mobile networks generate. This high dimensionality contains a lot of correlation between the features, which, combined with strong temporal dependence, creates a dataset that requires systems with strong modelling capability to process. Often, the dimensionality is reduced by hand-selecting features, and developing functions with only these few specific features. This approach creates functions that are very rigid and require constant maintenance in an evolving network.

The proposed system is easily adapted to different feature sets or new behaviour, it only requires a re-training, but no actual human labor. Since it is not targeted for specific hand-engineered features, the proposed mechanism can also be used to handle multi-vendor datasets. This can be done by training on the unified KPI set or using a form of transfer learning to correlate the two datasets.

One of the main design principles was to remove the need of data pre-processing through human labor. The proposed method should be able to handle ungroomed datasets straight from the network, without any need for feature reduction or aggregation.

The autoencoder models the correlations in the data, which makes the grouping more intelligent, as it is done on a well-presented dataset. This eliminates the usual over-representation of parts of the data that occurs when using prior methods. In mobile network management (particularly cognitive network management) the data contains very heterogenous and complex information. The proposed method is well suited for this type of input, making it a superb fit for mobile network applications.

The prototypes created by the DCA are well aligned for human interpretation (this was one of the main goals of the design at the first place). This makes both further machine processing more efficient and human understanding easier. This is especially true when the sparsity constraint of the degree of freedom is constrained below 1.0, since in this case essentially all data points are represented as a combination of at most two prototypes, which is naturally well understandable for humans. Due to this, the proposed method also naturally generates a state transition graph between similar states as shown in FIG. 7. This is an invaluable property, since network state graphs are extremely useful for a variety of cognitive network management applications.

FIG. 15 illustrates an embodiment. The figure illustrates a simplified example of an apparatus applying embodiments of the invention. In some embodiments, the apparatus may be a network element, or a part of a network element.

It should be understood that the apparatus is depicted herein as an example illustrating some embodiments. It is apparent to a person skilled in the art that the apparatus may also comprise other functions and/or structures and not all described functions and structures are required. Although the apparatus has been depicted as one entity, different modules and memory may be implemented in one or more physical or logical entities.

The apparatus 1500 of the example includes a control circuitry 1502 configured to control at least part of the operation of the apparatus.

The apparatus may comprise a memory 1504 for storing data. Furthermore, the memory may store software 1506 executable by the control circuitry 1502. The memory may be integrated in the control circuitry.

The apparatus may comprise one or more interface circuitries 1508, The interface circuitries are operationally connected to the control circuitry 1502. The interface circuitries may connect the apparatus to other network elements of the communication system in a wired or wireless manner as known in the art.

In an embodiment, the software 1506 may comprise a computer program comprising program code means adapted to cause the control circuitry 1502 of the apparatus to realise at least some of the embodiments described above.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

An embodiment provides a computer program embodied on a distribution medium, comprising program instructions which, when loaded into an electronic apparatus, are configured to control the apparatus to execute the embodiments described above.

The computer program may be in source code form, object code form, or in some intermediate form, and it may be stored in some sort of carrier, which may be any entity or device capable of carrying the program. Such carriers include a record medium, computer memory, read-only memory, and a software distribution package, for example. Depending on the processing power needed, the computer program may be executed in a single electronic digital computer or it may be distributed amongst several computers.

The apparatus may also be implemented as one or more integrated circuits, such as application-specific integrated circuits ASIC. Other hardware embodiments are also feasible, such as a circuit built of separate logic components. A hybrid of these different implementations is also feasible. When selecting the method of implementation, a person skilled in the art will consider the requirements set for the size and power consumption of the apparatus, the necessary processing capacity, production costs, and production volumes, for example.

In an embodiment, an apparatus comprises means for: [tdb]

It will be obvious to a person skilled in the art that, as the technology advances, the inventive concept can be implemented in various ways. The invention and its embodiments are not limited to the examples described above but may vary within the scope of the claims.

1. A network element for network state modelling of a communication network, comprising
an encoder module comprising at least one processor; and at least one memory including computer program code, the at least one memory and computer program code configured to, with the at least one processor, cause the network element to:
obtain as an input network data that is representative of the current condition of the communications network, the network data comprising a plurality of values indicative of the performance of network elements and perform feature reduction providing at its output a set of activations;
a clustering module comprising at least one processor; and at least one memory including computer program code, the at least one memory and computer program code configured to, with the at least one processor, cause the network element to:
perform batch normalisation and an amplitude limitation to the output of the encoder module;
a clustering control module comprising at least one processor; and at least one memory including computer program code, the at least one memory and computer program code configured to, with the at least one processor, cause the network element to:
obtain as an input data a sparsity constraint and the activations from the clustering module;
calculate a projection of the input data by utilising a mask controlled by the sparsity constraint;
determine a clustering loss controlling the clustering module by calculating distance between the activations and the projection;
a decoder module comprising at least one processor; and at least one memory including computer program code, the at least one memory and computer program code configured to, with the at least one processor, cause the network element to:
form from the output of the clustering module reconstructed network data and determine a reconstruction loss;
the network element being configured to backpropagate the reconstruction loss and the clustering loss through the modules of the network element to train the modules by gradually reducing the value of the sparsity constraint.

2. The network element of claim 1, wherein the mask removes the smallest activations based on the sparsity constraint.

3. The network element of claim 1, further configured to reduce the value of the sparsity constraint to between the range of [0,1].

4. The network element of claim 1, further configured to calculate a base change by
obtaining the output of the clustering module Q;
calculating affine subspace B={b₁, b₂, . . . , b_{D}} based on Q.
translating B with t=−b₁, to obtain B̅={0, b2−b1, . . . , bD−b1}.
obtaining base of the linear subspace B={b2−b1, . . . , bD−b1} which spanned by B̅;
orthogonalizing the base using a Gram-Schmidt orthogonalization to obtain orthogonalized A;
adding a unit length vector to A to obtain an orthonormal base as a matrix whose column are the elements of A; and
forming a matrix A whose column are the elements of A and storing A and t.

5. The network element of claim 4, further configured to
obtain as input the output activations of the clustering module Q;
sort the input in a descending order;
translate the sorted input by subtracting the value t;
change the base of the translated input to an orthonormal base utilising a transpose of the matrix A;
calculate the projection of the input data by multiplying the projection with the mask controlled by the given sparsity constraint;
change the base back to non-orthonormal utilising the matrix A;
perform detranslation by adding the value t;
perform unsorting to obtain anchor points \tilde{Q};
calculate clustering loss by determining distance between the anchor points \tilde{Q} and the activations Q.

6. The network element of claim 1, wherein the clustering module comprises a weight-shared batch normalization module followed by a sigmoid nonlinearity module configured to limit the values of the output of the batch normalization module to the range of [0,1].

7. The network element of claim 5, wherein the mask is a vector comprising values between [0, 1] based on the sparsity constraint.

8. A method for a network element, comprising:
obtaining by an encoder module as an input network data that is representative of the current condition of the communications network, the network data comprising a plurality of values indicative of the performance of network elements and perform feature reduction providing at its output a set of activations;
performing in a clustering module batch normalisation and an amplitude limitation to the output of the encoder module to obtain normalised activations;
obtaining by a clustering control module as an input a sparsity constraint, calculating a projection of the normalised activations by utilising a mask controlled by the sparsity constraint and determining a clustering loss controlling the clustering module by calculating distance between the normalised activations and the projection;
forming by a decoder module from the normalised activations reconstructed network data and determine a reconstruction loss; and
backpropagating, by the network element, the reconstruction loss and the clustering loss through the modules to train the modules by gradually reducing the value of the sparsity constraint.

9. The method of claim 8, wherein the mask removes the smallest activations based on the sparsity constraint.

10. The method of claim 8, further comprising: reducing the value of the sparsity constraint to between the range of [0,1].

11. The method of claim 8, further comprising: calculating a base change by
obtaining the output of the clustering module Q;
calculating affine subspace B={b₁, b₂, . . . , b_{D}} based on Q.
translating B with t=−b₁, to obtain B̅={0, b2−b1, . . . , bD−b1}.
obtaining base of the linear subspace B={b2−b1, . . . , bD−b1} which spanned by B̅;
orthogonalizing the base using a Gram-Schmidt orthogonalization to obtain orthogonalized A;
adding a unit length vector to A to obtain an orthonormal base as a matrix whose column are the elements of A; and
forming a matrix A whose column are the elements of A and storing A and t.

12. The method of claim 11, further comprising:
obtaining as input the output activations of the clustering module Q;
sorting the input in a descending order;
translating the sorted input by subtracting the value t;
changing the base of the translated input to an orthonormal base utilising a transpose of the matrix A;
calculating the projection of the input data by multiplying the projection with the mask controlled by the given sparsity constraint;
changing the base back to non-orthonormal utilising the matrix A;
performing detranslation by adding the value t;
performing unsorting to obtain anchor points \tilde{Q};
calculating clustering loss by determining distance between the anchor points \tilde{Q} and the activations Q.

13. The method of claim 8, further comprising:
performing in the clustering module a weight-shared batch normalization and limiting the values of the output of the batch normalization to the range of [0,1].

14. A computer program comprising instructions for causing an apparatus to perform at least the following:
obtaining by an encoder module as an input network data that is representative of the current condition of the communications network, the network data comprising a plurality of values indicative of the performance of network elements and perform feature reduction providing at its output a set of activations;
performing in a clustering module batch normalisation and an amplitude limitation to the output of the encoder module to obtain normalised activations;
obtaining by a clustering control module as an input a sparsity constraint, calculating a projection of the normalised activations by utilising a mask controlled by the sparsity constraint and determining a clustering loss controlling the clustering module by calculating distance between the normalised activations and the projection;
forming by a decoder module from the normalised activations reconstructed network data and determine a reconstruction loss; and
backpropagating the reconstruction loss and the clustering loss through the modules to train the modules by gradually reducing the value of the sparsity constraint
